(19) United States
(12) Patent Application Publication
(10) Pub. No.: US 2014/0111983 A1
(43) Pub. Date: Apr. 24, 2014

(54) LIGHT-EMITTING DIODE TUBE

(71) Applicants: Lextar Electronics Corporation, Hsinchu (TW); Lextar Electronics (SuZhou) Corporation, Jiang Su (CN)

(72) Inventor: Ji-Hui Yang, Jiangsu Province (CN)

(73) Assignees: Lextar Electronics Corporation, Hsinchu (TW); Lextar Electronics (SuZhou) Corporation, Jiang Su (CN)

(21) Appl. No.: 13/955,066

(22) Filed: Jul. 31, 2013

(30) Foreign Application Priority Data
Oct. 22, 2012 (CN) 201210404768.6

(51) Int. Cl. F21K 99/00

(52) U.S. Cl. CPC F21K 9/175
USPC 362/222

(57) ABSTRACT

A light-emitting diode tube, comprising a base, a fixing cover, an LED, a lampshade, a driver and a sliding cover is provided. The base has a first carrying surface and a second carrying surface, and a pair of first guiding rail and second guiding rail parallel to each other. The second carrying surface comprises a first area and a second area. The fixing cover is fixedly disposed on the guiding rail located in the first area of the second carrying surface, and covers the first area of the second carrying surface. The LED is disposed on the first carrying surface. The lampshade is located over the first carrying surface and fixed to the base and covers the LED. The driver is disposed in the second area of the second carrying surface. The sliding cover movably covers the second area of the second carrying surface or the fixing cover.

This application claims the benefit of People's Republic of China application Serial No. 201210404768.6, filed Oct. 22, 2012, the subject matter of which is incorporated herein by reference.

### BACKGROUND OF THE INVENTION

1. Field of the Invention

The invention relates in general to a light-emitting diode tube, and more particularly to a light-emitting diode tube capable of improving the maintainability of a driver.

2. Description of the Related Art

Conventional light emitting device comprises a lamp shell, a base, a light source and a driver. The light source and the driver are disposed on the base. The driver is for driving the light source. The lamp shell covers the light source and the driver and is fixed to the base.

However, since the lamp shell is fixed to the base, it is difficult to maintain the driver of the light emitting device; hence the light emitting device ends up with being discarded when the driver is damaged.

### SUMMARY OF THE INVENTION

The invention is directed to a light-emitting diode tube capable of improving the maintainability of a driver of the light-emitting diode tube.

According to an embodiment of the present invention, a light-emitting diode tube is provided. The light-emitting diode tube comprises a base, a fixing cover, a light-emitting diode (LED), a lampshade, a driver and a sliding cover. The base has a first carrying surface and a second carrying surface opposite to the first carrying surface, and a pair of first guiding rail and second guiding rail which are disposed on the second carrying surface and parallel to each other. The second carrying surface comprises a first area and a second area. The fixing cover is fixedly disposed on the guiding rail located in the first area, and covers the first area of the second carrying surface. The LED is disposed on the first carrying surface. The lampshade is located over the first carrying surface and fixed to the base and covers the LED. The driver is disposed in the second area of the second carrying surface. The sliding cover dynamically covers the second area of the second carrying surface or the fixing cover.

According to another embodiment of the present invention, a light-emitting diode tube is provided. The light-emitting diode tube comprises a base, an LED, a driver, a lampshade, a first sub-cover and a second sub-cover. The base has a first carrying surface and a second carrying surface opposite to the first carrying surface. The LED is disposed on the first carrying surface. The driver is disposed on the second carrying surface. The lampshade is located over the first carrying surface and fixed to the base, and covers the LED. The first sub-cover is located over the second carrying surface having a first terminal portion and a second terminal portion. The first terminal portion of the first sub-cover is connected to the base. The second sub-cover is located over the second carrying surface, and has a first terminal portion and a second terminal portion. The first terminal portion of the second sub-cover is connected to the base. The second terminal portion of the second sub-cover can be separately engaged with the second terminal portion of the first sub-cover to selectively expose or cover the driver.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows an appearance view of a light-emitting diode tube according to an embodiment of the invention;

FIG. 2 shows an appearance view of a base and a fixing cover of FIG. 1;

FIG. 3 shows a partial appearance view of a sliding cover of FIG. 1 covering a fixing cover.

FIG. 4 shows an appearance view of a reversed sliding cover of FIG. 3;

FIG. 5 shows an appearance view of the sliding cover of FIG. 1 covering a second area of a second carrying surface;

FIG. 6 shows an appearance view of a light-emitting diode tube according to another embodiment of the invention;

FIG. 7 shows a cross-sectional view along a direction 7-7′ of FIG. 6.

### DETAILED DESCRIPTION OF THE INVENTION

A number of embodiments are disclosed below for elaborating the objects, structures, features and functions of the light emitting diode tube of the invention.

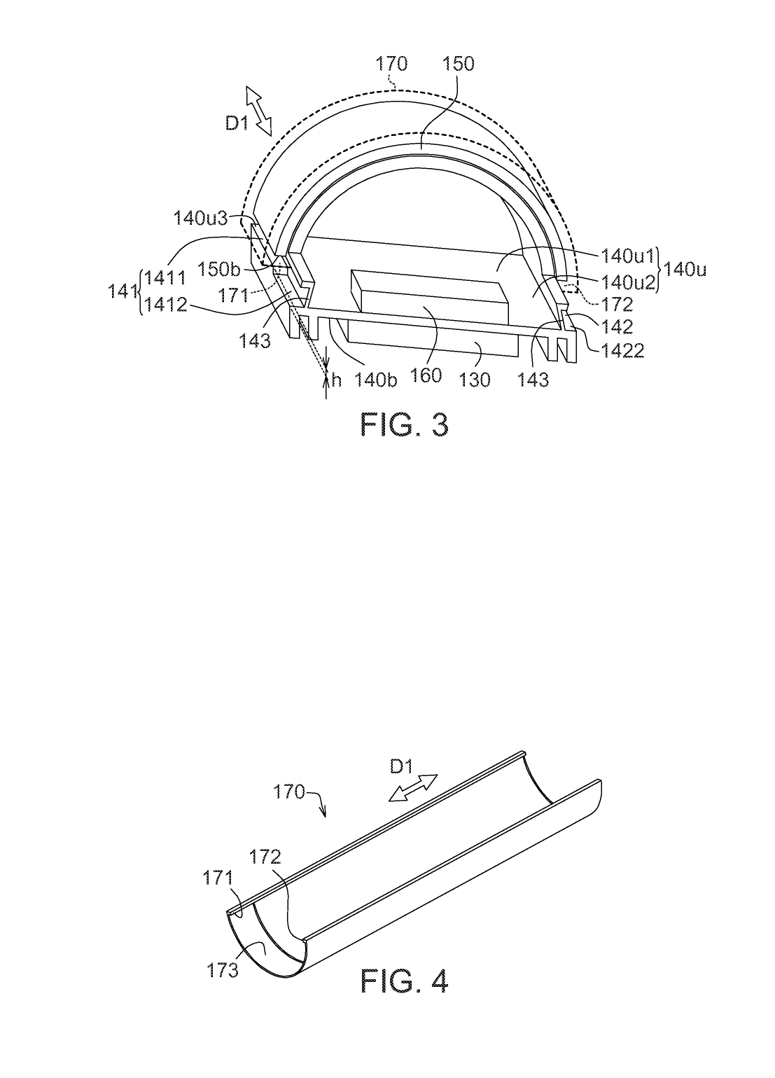

Referring to FIGS. 1 and 3. FIG. 1 shows an appearance view of a light-emitting diode tube according to an embodiment of the invention. FIG. 3 shows a partial appearance view of a sliding cover of FIG. 1 covering a fixing cover. The light-emitting diode tube 100 comprises two lamp caps 110, a lampshade 120, at least a light-emitting diode (LED) 130, a base 140, a fixing cover 150, a driver 160 and a sliding cover 170.

The two lamp caps 110 are respectively mounted on two opposite ends of the base 140 and the lampshade 120, and further fix the base 140 and the lampshade 120.

The lampshade 120 covers the first carrying surface 140b of the base 140 (see FIG. 3), and is located over the first carrying surface 140b of the base 140. The lampshade 120 is fixed to the base 140, and covers the LED 130. The LED 130 is disposed on the first carrying surface 140b of the base 140.

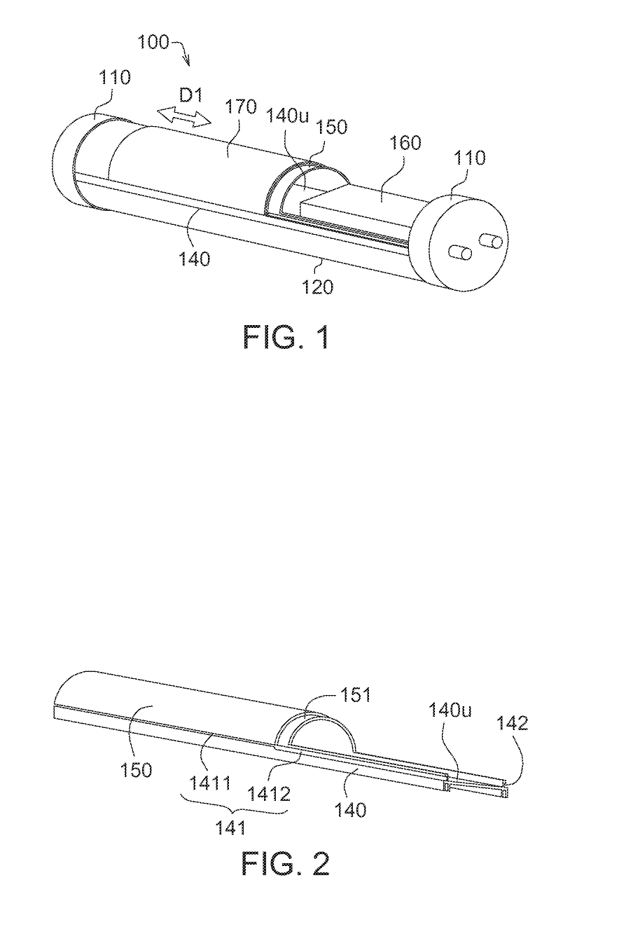

Referring to FIG. 2, an appearance view of a base and a fixing cover of FIG. 1 is shown. The base 140 is formed by such as metal or ceramics. The base 140 has a second carrying surface 140u opposite to the first carrying surface 140b and a pair of first guiding rail 141 and second guiding rail 142 parallel to each other. The first guiding rail 141 and the second guiding rail 142 are disposed on the second carrying surface 140u.

Referring to FIG. 3. The second carrying surface 140u comprises a first area 140u1 and a second area 140u2. The fixing cover 150 is fixedly disposed on the first guiding rail 141, and covers the first area 140u1 of the second carrying surface 140u. In the present example, the fixing cover 150 and the base 140 are integrally formed in one piece. Alternatively, the fixing cover 150 and the base 140 can be formed separately and then are combined together by way of engaging or bonding.

As indicated in FIG. 3, the first guiding rail 141 is constituted by the first sub-guiding rail 1411 located in the first area 140u and the second sub-guiding rail 1412 located in the second area 140u2. The first sub-guiding rail 1411 slides in a sliding space defined between the lower surface 150b of the fixing cover 150 and the upper surface 140u3 of the base 140. The base 140 comprises a sidewall 143 disposed in the second area 140u2, and the second sub-guiding rail 1412 is disposed in the second area 140u2 and is defined in a sliding space between the sidewall 143 and the second area 140u2. Since the bottom surface (the upper surface 140u3) of the first sub-guiding rail 1411 is higher than the bottom surface (the second area 140u2) of the second sub-guiding rail 1412, a height difference h between the bottom surface of the first sub-guiding rail 1411 and that of the second sub-guiding rail 1412 is larger than zero. Similarly, the second guiding rail 142 is constituted by the third sub-guiding rail (not illustrated in FIG. 3) located in the first area 140u1 and the fourth sub-guiding rail 1422 located in the second area 140u2. The structures of the third sub-guiding rail and the fourth sub-guiding rail 1422 are respectively similar to that of the first sub-guiding rail 1411 and the second sub-guiding rail 1412. A height difference also exists between the third sub-guiding rail and the fourth sub-guiding rail 1422. Through the height difference, when the sliding cover 170 of FIG. 3 slides towards the driver 160 until covering the driver 160, the sliding cover 170 falls in the second sub-guiding rail 1412 and the fourth sub-guiding rail 1422 to inform the operator that the sliding cover 170 has covered the driver 160. The driver 160 is disposed in the second area 140u2 of the second carrying surface 140u.

The driver 160 is disposed on the second area 140u2 of the second carrying surface 140u. Referring to both FIG. 3 and FIG. 4. FIG. 4 shows an appearance view of a reversed sliding cover of FIG. 3. A first sliding device 171 and a second sliding device 172 are respectively disposed at two sides of the sliding cover 170 in an extension direction D1 parallel to the first guiding rail 141 and the second guiding rail 142 of the base 140 so as to dynamically slide in the first guiding rail 141 and the second guiding rail 142. The first sliding device 171 and the second sliding device 172 are such as strip-shaped sliding ribs protruded inwardly or rollers protruded inwardly. The first sliding device 171 and the second sliding device 172 respectively slide along the first guiding rail 141 and the second guiding rail 142, such that the sliding cover 170 dynamically covers the second area 140u2 of the second carrying surface 140u or the fixing cover 150 to cover or expose the driver 160. When the driver 160 needs to be exposed, the user only needs to slide the sliding cover 170, and the driver 160 (see FIG. 1) will be exposed for repairment or replacement.

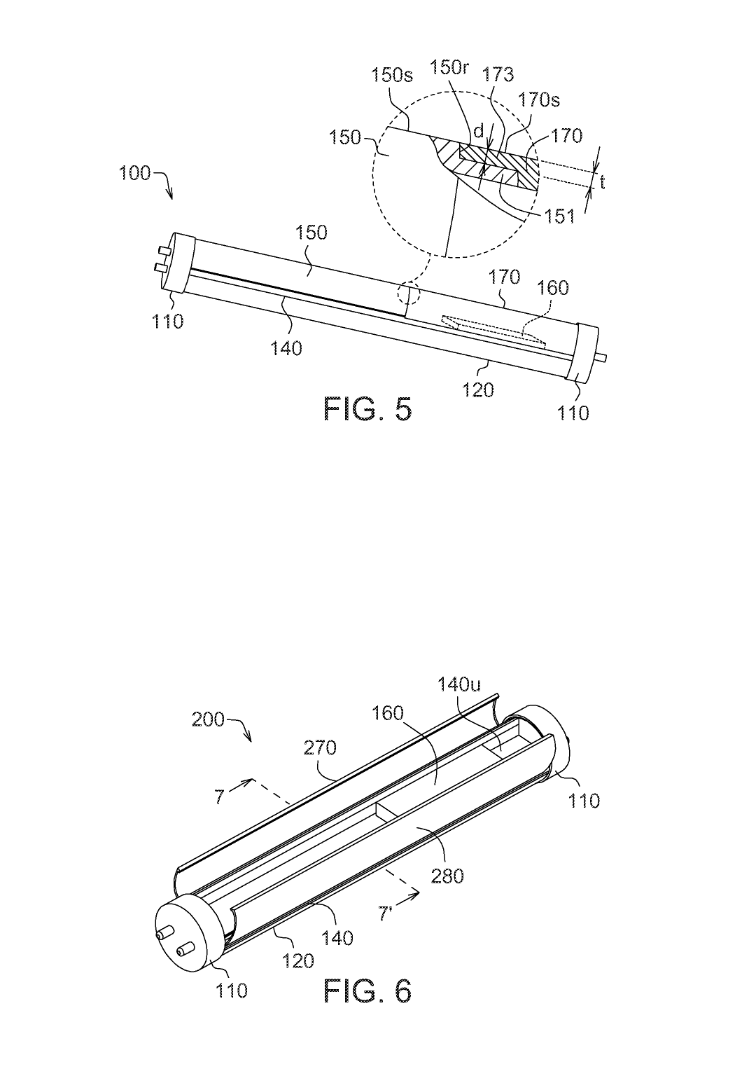

Referring to FIG. 5, an appearance view of the sliding cover of FIG. 1 covering a second area of a second carrying surface is shown. When the driver 160 needs to be covered, the user only needs to slide the sliding cover 170 of FIG. 3 towards the driver 160 until covering the driver 160. Besides, the fixing cover 150 has a depressed area 150r corresponding to the second area 140u2 of the second carrying surface 140u, such that when the sliding cover 170 slides to the second area 140u2 of the second carrying surface 140u, the edge terminal 173 of the sliding cover 170 overlaps the depressed area 150r. The depressed area 150r is extended inwards for a distance from the outer surface 150s of the fixing cover 150 to form a supporting portion 151. After the sliding cover 170 slides to the second area 140u2 from the first area 140u1 to completely cover the second area 140u2, the edge terminal 173 of the sliding cover 170 falls in the depressed area 150r and leans on the supporting portion 151. In the present example, a depth d of the depressed area 150r of the fixing cover 150 is equal to a thickness t of the sliding cover 170. After the sliding cover 170 completely covers the second area 140u2, the outer surface 150s of the fixing cover 150 is aligned with the outer surface 170s of the sliding cover 170, and the edge terminal 173 of the sliding cover 170 partly overlaps the fixing cover 150 at the junction between the fixing cover 150 and the sliding cover 170. In another example, the depth d and the thickness t can be different from each other.

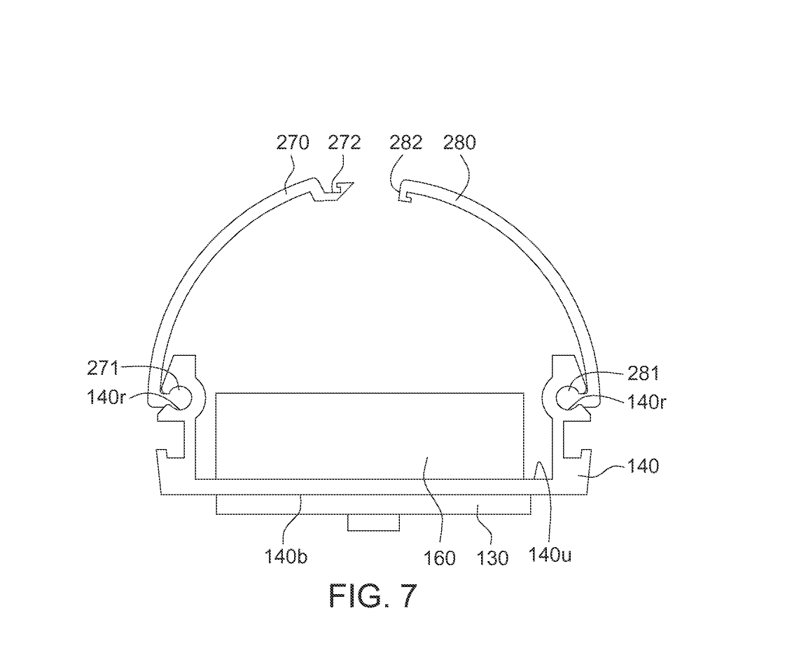

Referring to FIG. 6 and FIG. 7. FIG. 6 shows an appearance view of a light-emitting diode tube according to another embodiment of the invention. FIG. 7 shows a cross-sectional view along a direction 7-7′ of FIG. 6. The light-emitting diode tube 200 comprises two lamp caps 110, a lampshade 120, an LED 130, a base 140, a driver 160, a first sub-cover 270 and a second sub-cover 280.

As indicated in FIG. 7, the lampshade 120 covers the first carrying surface 140b of the base 140, and is located over the first carrying surface 140b. The lampshade 120 is fixed to the base 140, and covers the LED 130.

The base 140 has a second carrying surface 140u opposite to the first carrying surface 140b. The LED 130 is disposed on the first carrying surface 140b of the base 140. The driver 160 is disposed on the second carrying surface 140u of the base 140.

The first sub-cover 270 is located over the second carrying surface 140u having a first terminal portion 271 and a second terminal portion 272. The first terminal portion 271 of the first sub-cover 270 is connected to the base 140.

The second sub-cover 280 is located over the second carrying surface 140u having a first terminal portion 281 and a second terminal portion 282. The first terminal portion 281 of the second sub-cover 280 is connected to the base 140. The second terminal portion 282 of the second sub-cover 280 can be separately engaged with the second terminal portion 272 of the first sub-cover 270 to selectively expose or cover the driver 160.

The second terminal portion 272 of the first sub-cover 270 has a recess, and the second terminal portion 282 of the second sub-cover 280 has a hook. Through the design of the recess and the hook, the first sub-cover 270 and the second sub-cover 280 can be engaged with each other. In another example, the second terminal portion 272 of the first sub-cover 270 has a hook, and the second terminal portion 282 of the second sub-cover 280 has a recess.

Each of the first terminal portion 271 of the first sub-cover 270 and the first terminal portion 281 of the second sub-cover 280 is a connector, and the base 140 has a connector recess 140r matching the recess. As the connector is pivotally connected to the connector recess 140r, the first sub-cover 270 and the second sub-cover 280 may rotate with respect to the connector recess more easily. In the present example, the connector is a cylindrical connector, and the connector recess is a cylindrical recess corresponding to the cylindrical connector. However, the type of the connector and the connector recess are not subjected to particular restrictions in the embodiment of the invention.

The first sub-cover 270 and the second sub-cover 280 both are a flexible cover. In the present example, the first sub-cover 270 and the second sub-cover 280 are formed by polymer, metal or a composite material. The flexibility of the first sub-cover 270 and the second sub-cover 280 can be achieved through the design of material characteristic, dimension and/or thickness of the first sub-cover 270 and the second sub-cover 280. As the cover is formed by a flexible material, the first sub-cover 270 and the second sub-cover 280 can be engaged with or separated from each other more easily.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A light-emitting diode tube, comprising:
a base having a first carrying surface and a second carrying surface opposite to the first carrying surface, and a pair of first guiding rail and second guiding rail parallel to each other, wherein the first guiding rail and the second guiding rail are disposed on the second carrying surface having a first area and a second area; and
a fixing cover fixedly disposed on the first guiding rail and the second guiding rail located at the first area of the second carrying surface and covering the first area of the second carrying surface;
a light-emitting diode (LED) disposed on the first carrying surface;
a lampshade located over the first carrying surface and fixed to the base and covering the LED;
a driver disposed in the second area of the second carrying surface;
a sliding cover dynamically covering the second area of the second carrying surface or the fixing cover.

2. The light-emitting diode tube according to claim 1, wherein the fixing cover has a depressed area corresponding to the second area of the second carrying surface, and when the sliding cover slides to the second area of the second carrying surface, an edge of the sliding cover overlaps the depressed area.

3. The light-emitting diode tube according to claim 2, wherein a depth of the depressed area of the fixing cover is equal to a thickness of the sliding cover, and after the sliding cover slides to the second area from the first area to completely covers the second area, the sliding cover partly overlaps the fixing cover at a junction area between the sliding cover and the fixing cover, and a surface of the sliding cover is aligned with a surface of the fixing cover.

4. The light-emitting diode tube according to claim 1, wherein a first sliding device and a second sliding device are respectively disposed at two sides of the sliding cover in a direction parallel to an extension direction of the first guiding rail so as to dynamically slide in the first guiding rail and the second guiding rail.

5. The light-emitting diode tube according to claim 4, wherein the first and the second sliding device are strip-shaped sliding ribs protruded inwardly or rollers protruded inwardly.

6. The light-emitting diode tube according to claim 1, wherein the first guiding rail is constituted by the first sub-guiding rail located in the first area and the second sub-guiding rail located in the second area, the second guiding rail is constituted by the third sub-guiding rail located in the first area and the fourth sub-guiding rail located in the second area, and a height difference between the first sub-guiding rail and the second sub-guiding rail is larger than zero, and a height difference between the third sub-guiding rail and the fourth sub-guiding rail is larger than zero.

7. The light-emitting diode tube according to claim 2, wherein the first guiding rail is constituted by the first sub-guiding rail located in the first area and the second sub-guiding rail located in the second area, the second guiding rail is constituted by the third sub-guiding rail located in the first area and the fourth sub-guiding rail located in the second area, and a height difference between the first sub-guiding rail and the second sub-guiding rail is larger than zero, and a height difference between the third sub-guiding rail and the fourth sub-guiding rail is larger than zero.

8. The light-emitting diode tube according to claim 3, wherein the first guiding rail is constituted by the first sub-guiding rail located in the first area and the second sub-guiding rail located in the second area, the second guiding rail is constituted by the third sub-guiding rail located in the first area and the fourth sub-guiding rail located in the second area, and a height difference between the first sub-guiding rail and the second sub-guiding rail is larger than zero, and a height difference between the third sub-guiding rail and the fourth sub-guiding rail is larger than zero.

9. The light-emitting diode tube according to claim 4, wherein the first guiding rail is constituted by the first sub-guiding rail located in the first area and the second sub-guiding rail located in the second area, the second guiding rail is constituted by the third sub-guiding rail located in the first area and the fourth sub-guiding rail located in the second area, and a height difference between the first sub-guiding rail and the second sub-guiding rail is larger than zero, and a height difference between the third sub-guiding rail and the fourth sub-guiding rail is larger than zero.

10. The light-emitting diode tube according to claim 5, wherein the first guiding rail is constituted by the first sub-guiding rail located in the first area and the second sub-guiding rail located in the second area, the second guiding rail is constituted by the third sub-guiding rail located in the first area and the fourth sub-guiding rail located in the second area, and a height difference between the first sub-guiding rail and the second sub-guiding rail is larger than zero, and a height difference between the third sub-guiding rail and the fourth sub-guiding rail is larger than zero.

11. The light-emitting diode tube according to claim 1, wherein the fixing cover and the base are integrally formed in one piece.

12. A light-emitting diode tube, comprising:
a base having a first carrying surface and a second carrying surface opposite to the first carrying surface;
an LED disposed on the first carrying surface;
a driver disposed on the second carrying surface;
a lampshade located over the first carrying surface and fixed to the base and covering the LED;
a first sub-cover located over the second carrying surface having a first terminal portion and a second terminal portion, wherein the first terminal portion of the first sub-cover is connected to the base; and
a second sub-cover located over the second carrying surface having a third terminal portion and a fourth terminal portion, wherein the third terminal portion of the second sub-cover is connected to the base, and the fourth terminal portion of the second sub-cover can be separately engaged with the second terminal portion of the first sub-cover to selectively expose or cover the driver.

13. The light-emitting diode tube according to claim 12, wherein one of the second terminal portion of the first sub-cover and the fourth terminal portion of the second sub-cover has a recess, and the other one of the second terminal portion of the first sub-cover and the fourth terminal portion of the second sub-cover has a hook.

14. The light-emitting diode tube according to claim 12, wherein each of the first sub-cover and the second sub-cover is a flexible cover.

15. The light-emitting diode tube according to claim 12, wherein each of the first terminal portion of the first sub-cover and the third terminal portion of the second sub-cover is a connector, and the base has a connector recess to which the connector is pivotally connected.

16. The light-emitting diode tube according to claim 15, wherein the connector is a cylindrical connector, and the connector recess is a cylindrical recess corresponding to the cylindrical connector.
